(19) United States
(12) Patent Application Publication
(10) Pub. No.: US 2002/0161825 A1
(43) Pub. Date: Oct. 31, 2002

(54) Workflow system with correction confirmation mode

(75) Inventors: Makoto Kogoh, Yamato-shi (JP); Ryohichi Yoshimura, Sagamihara-shi (JP); Hiroyasu Ohsaki, Sagamihara-shi (JP)

Correspondence Address: Gerald R. Woods, IBM Corporation, T81/503, PO Box 12195, Research Park, NC, 27709, US

(73) Assignee: International Business Machines Corporation, Armonk, NY

(21) Appl. No.: 10/131,689

(22) Filed: Apr. 24, 2002

(30) Foreign Application Priority Data
Apr. 27, 2001 (JP) 2001-133512

(51) Int. Cl. G06F 15/16

(52) U.S. Cl. 709/202; 709/242; 709/205

(57) ABSTRACT

A workflow system includes an inquiry element that responds to corrections in data at a given stage on a workflow route to inquire of an activity to which the processed results are sent back whether it agrees on the correction. The system also includes a management element for means for forwarding accepted corrected data to an activity on the route of the workflow following the activity at the given stage, bypassing the given stage.

### FIELD OF THE INVENTION

The present invention relates to a workflow system, and more particularly to a workflow system that simplifies steps that must be taken when initially-entered data is unsatisfactory.

### BACKGROUND OF THE INVENTION

A paperless form processing system may be constructed by using a workflow system that computerizes and manages information flow in business affairs. In a workflow system, complex business processes are managed by defining a series of less-complex business processes executed in series. Using this type of system to manage the business form processing on a computer may prevent mistakes and lost time, thereby improving an operational efficiency.

FIG. 9 is a general illustration of work flow during processing of application forms. An applicant (issuer) 901, a first approver (e.g., a superior of the applicant) 902, and a second approver (e.g., an administrative department of the applicant) 903 are shown as participants in the work flow. After applicant 901 creates form data, first approver 902 may approve this form data. If the form data is approved by first approver 902, the form data is sent on to a second approver 903, who may likewise approve this form data.

If the form data does not meet approval conditions at first approver 902, that form data is sent back from first approver 902 to applicant 901. On receipt of the form sent back, applicant 901 corrects the application contents so as to meet the approval conditions and resends the corrected form data to first approver 902. First approver 902 receives the corrected form data and checks the application contents again. This process is repeated as long as the form data does not meet the approval conditions. Once the form data meets the approval conditions, first approver 902 approves this form data and sends it to second approver 903.

It should be noted that if the workflow system is computerized form data, terms such as “send back”, “resend” and “send” don't necessarily mean a physical transfer of the form data. The approvers may not even electronically return any submitted forms but may tell the applicant, via e-mail or voice, what is wrong with the submitted form data.

In the above-mentioned workflow system, because steps such as “issue”, “approve” and “reject” in each activity must always be performed, there is a limit to how much processing efficiency can be improved. The processing efficiency of the workflow system is largely influenced by the structure of the processes of the workflow system.

Conventional workflow systems must perform processes such as a “send back”, “resend” and “approve” even if mistakes are minor, such as when the company name of a correspondent firm specified in the form data is erroneously entered or when an amount billed slightly exceeds an upper limit, or when it is desired that a due date be extended a bit. No matter how minor the mistake, the processing is delayed due to the need to repeat all of the processes defined in the workflow system.

On the other hand, if an attempt is made to speed up processing by allowing any transactor in the workflow to make corrections of form data by any transactor on a route of workflow other than an applicant, it becomes unclear whether transactors prior to the correcting transactor would have agreed with the correction. This results in an ambiguity as to who has responsibility for the application contents.

It is an object of the present invention to provide a workflow system in which authority to correct the application contents of an applicant is delegated to transactors in the workflow route.

It is another object of the invention to define a workflow system in which the responsibility for application content corrections is clearly assigned to a transactor or transactors on the workflow route.

### SUMMARY OF THE INVENTION

The present invention is a system for managing a series of business processes in a workflow performed by multiple terminal devices connected to a network. The system includes an inquiry element. If a processed result of a certain activity (the first activity) is corrected and sent back by another activity (the second activity) on a workflow route of the workflow, the inquiry element queries the first activity to determine whether it agrees on the correction. If the query indicates the first activity agrees with the corrections, a management element sends the corrected result on to a third activity, bypassing the second activity on the workflow route.

If the first activity makes further changes in the material sent back to it, the management element causes the changed results to be returned to the second activity. The management element preferably also distributes the results finally approved by the first activity to be distributed to other activities having need of the results.

### BRIEF DESCRIPTION OF THE DRAWINGS

While the specification concludes with claims particularly pointing out and distinctly claiming that which is regarded as the present invention, details of a preferred embodiment of the invention may be more readily ascertained from the following detailed description when read in conjunction with the accompanying drawings wherein:

FIG. 1 depicts a complete workflow system according to the embodiment of the present invention;

FIG. 2 is a diagram illustrating a form definition table according to the embodiment of the present invention;

FIG. 3 is a diagram illustrating an application information table according to the embodiment of the present invention;

FIG. 4 is a diagram illustrating a status information table according to the embodiment of the present invention;

FIG. 5 is a diagram illustrating business processes in a workflow system according to the embodiment of the present invention;

FIG. 6 is a flowchart illustrating the processing performed by a form management section in the workflow system according to the embodiment of the present invention;

FIG. 7 depicts an example configuration of a display screen of the form displayed by a browser in a client according to the embodiment of the present invention;

FIG. 8 is a flowchart illustrating operations performed by a form edit/display control section according to the embodiment of the present invention; and

FIG. 9 depicts an example flow of business processes for conventional processing of application forms.

### DETAILED DESCRIPTION

The present invention is a system under which authority to correct form data can be granted to transactors on the workflow route. To make it clear where the responsibility lies for the contents of the form data corrected by a transactor on the workflow route, a mechanism is provided for transactors at previous stages on the route to confirm corrections made by such transactor.

A workflow system according to the present invention introduces a process referred to as “approval with correction confirmation”. In order to implement this process, a property called correction confirmation property is defined. This correction confirmation property may be set for activities or for form data subject to application. When it is set for an activity, the activity is to have an authority to correct various kinds of form data. On the other hand, when being set for form data, selecting an input field allows only a specific input field to accept correction associated with an activity. Each activity on the workflow can correct the application contents based on the correction confirmation property, wherein the form data will be in a correction confirmation mode when the correction is made.

The correction confirmation mode is further classified into a correction confirmation request mode and a correction confirmed mode. Form data in the correction confirmation request mode is sent back to a transactor (activity) specified by an activity where the correction is made. If the transactor to whom the form data is sent back accepts the correction, the mode of the form data will be changed to the correction confirmed mode. The form data in the correction confirmed mode proceeds to a next activity with skipping the activity where the correction was made based on the correction confirmation property.

As described above, with the approval with correction confirmation process, when the transactors at the previous stages accept the correction of form data made by a transactor on the route, the process proceeds to a next activity bypassing the transactor at which the correction was made. Namely, when performing the approval with correction confirmation process, the transactor that corrects the form data approves the form data on condition that the correction is accepted by the transactors at the previous stages.

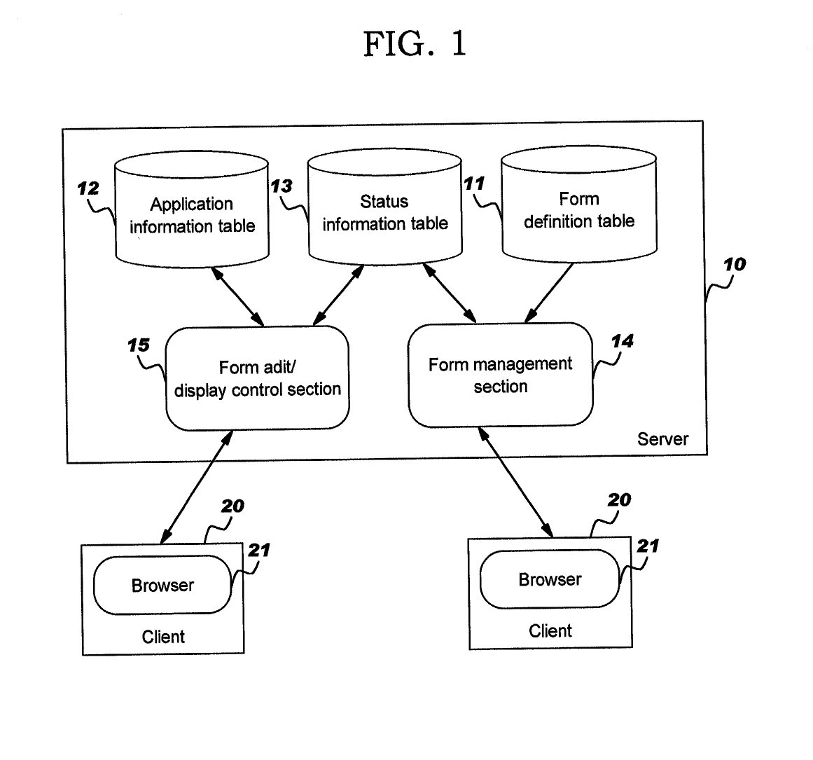

Referring to FIG. 1, the workflow system of the present invention comprises a server 10 that performs information management of business affairs based on a workflow for managing form processing, and clients 20 where the transactors (e.g., an applicant, approvers) of activities managed by the workflow perform the business affairs.

Server 10 is a workflow server that comprises a storage device (e.g., magnetic disk drives, semiconductor memories) for storing data concerning the business affairs and a data processor for performing data processing based on the workflow. Specifically, server 10 may be implemented as a computer such as a personal computer or workstation.

Client 20 is an information-processing terminal that includes a display for representing business affairs on the workflow and an input device (e.g., keyboard). Specifically, client 20 may be implemented as a computer such as a personal computer or workstation or as a PDA (personal digital assistant).

In FIG. 1, server 10 includes code representing a form definition table 11 for storing form data (hereinafter referred to as form) managed in the workflow; an application information table 12 for storing information about application contents (hereinafter referred to as application information) in the form; a status information table 13 for managing status data of the form in the workflow, which corresponds to the application information stored in application information table 12; a form management section 14 for managing forms in the workflow; and form edit/display control section 15 connected to client 20 and providing a display screen (interface) for form processing. In the above configuration, form management section 14 and form edit/display control section 15 are software blocks implemented by a program-controlled CPU. A computer program for controlling the CPU may be delivered with being stored in storage media such as a CD-ROM or floppy disk or may be transmitted via a network. Moreover, client 20 includes a browser 21 for displaying a display screen which can be used for editing forms based on control provided by form edit/display control section 15.

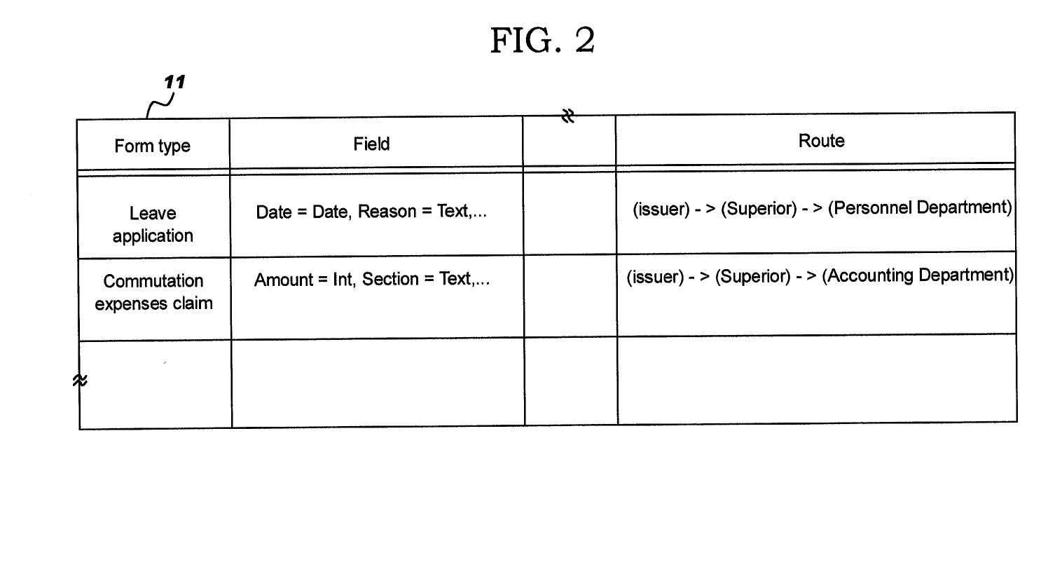

FIG. 2 is a diagram illustrating form definition table 11. Form definition table 11 consists of records for each form types, wherein each record stores information about items including (for one type of form) at least a “field” and “route”. The “field” defines items that are input with regard to the form. The “route” defines a route (process) that the form is to essentially take on the workflow. FIG. 2 shows the names of transactors for activities on the route. For example, referring to FIG. 2, with regard to a leave application form, input items such as a date and reason are defined in the “Field”, while entries in the “Route” field defined that this form should be processed serially by an issuer, a superior and a personnel department.

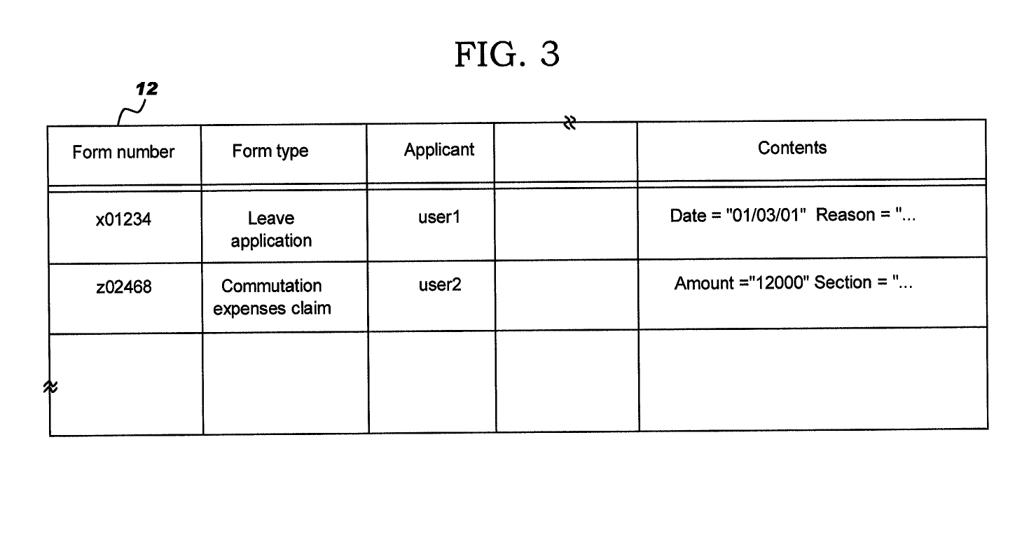

FIG. 3 is a diagram illustrating an application information table 12. The application information table 12 consists of records for each form, wherein each record stores information about items including at least a “form number”, “form type”, “applicant” and “contents”. The “form type” corresponds to “form type” in form definition table 11 of FIG. 2. The “contents” are application contents of the form, in which there are shown the contents input corresponding to items defined in the “field” of form definition table 11.

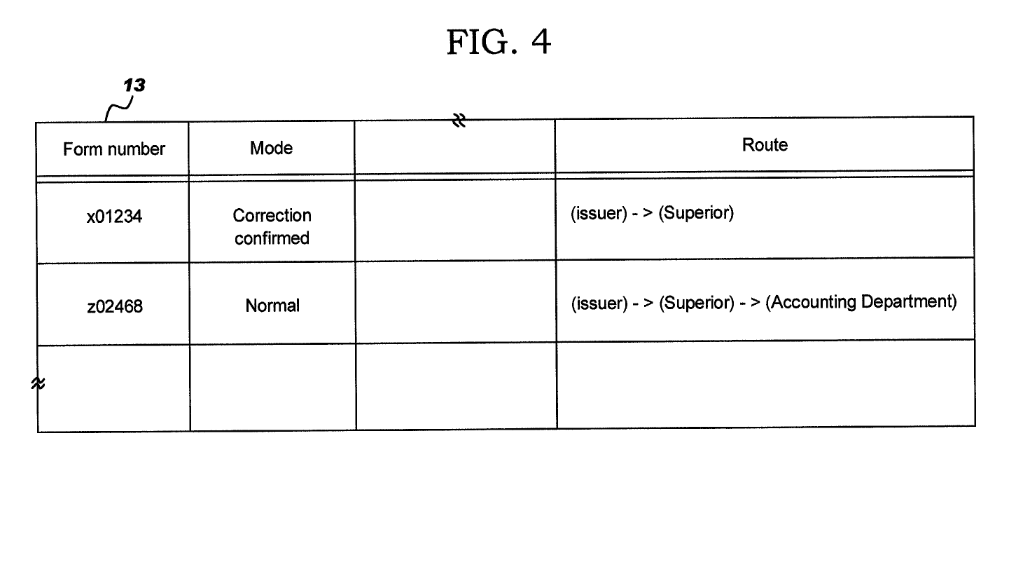

FIG. 4 is a diagram illustrating status information table 13. The status information table 13 consists of records for each form, wherein each record stores information about items preferably including at least a “form number”, “mode” and “route”. The “mode” indicates what process the form is involved in. According to the embodiment of the present invention, there are defined a correction confirmation request mode and a correction confirmed mode in order to perform the approval with correction confirmation process, as described above. FIG. 4 does not show the correction confirmation request mode. “Route” fields, if part of the table, show a route where the form has passed so far (i.e., activities performed and their order). FIG. 4 shows the names of transactors involved in the activities on the route.

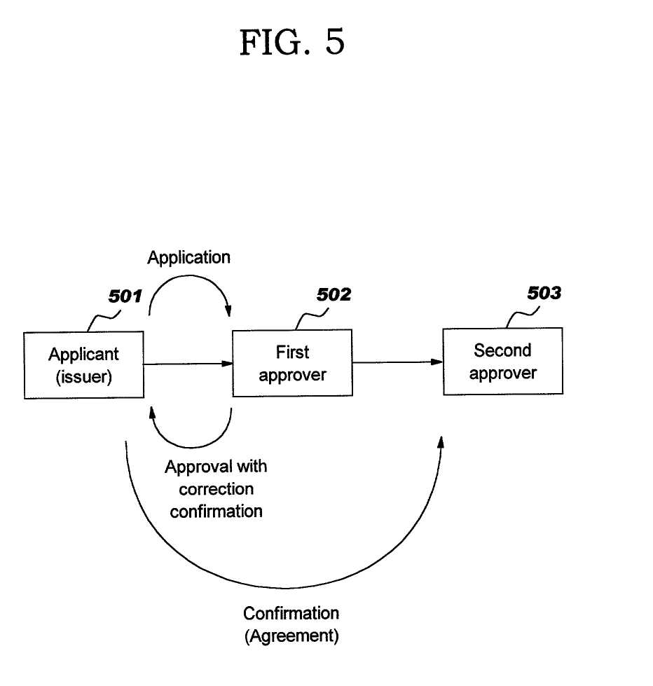

FIG. 5 is a diagram illustrating business processes in a workflow system configured as described above. In the workflow shown in FIG. 5, the business processes are performed following the procedure where first an applicant (issuer) 501 creates the form data, then a first approver 502 approves this form data and then a second approver 503 approves this form data. Referring to form definition table 11 shown in FIG. 2, for leave application form, the first approver 502 is a superior and the second approver 503 is a personnel department. For the commutation expenses claim form, the first approver 502 is a superior and the second approver 503 is an accounting department. It should be noted that the correction confirmation property is established for an activity of the first approver 502. That is, the first approver 502 is able to perform the approval with correction confirmation. In FIG. 5, according to the essential business processes, a form created by applicant 501 is approved by the first approver 502 and then by the second approver 503. This process is the same as the description shown in the “route” in the form definition table 11 shown in FIG. 2. When the form is in a normal mode, that is, the “mode” is set to be “normal” in the status information table 13 of FIG. 4, each activity is to be performed according to this route.

Here it is assumed that the form created by an applicant 501 does not meet the approval conditions at the first approver 502. In this case, since the correction confirmation property is established for an activity of the first approver 502, he can correct the form. Accordingly, the first approver 502 makes necessary corrections to the form and sends it back to the applicant 501. At this time, the mode of this form becomes a “correction confirmation request” mode in the status information table 13 shown in FIG. 4. The change of mode from a normal mode to a correction confirmation request mode may be performed by the first approver 502 inputting a predetermined command from client 20 or may be automatically performed by the first approver 502 sending back the form to applicant 501 after modifying the contents of the form.

When the form in the correction confirmation request mode is sent back to applicant 501, he transfers the form to a next activity as it is if he accepts the corrected contents and agrees on the correction. Namely, applicant 501 sends the form to the second approver 503 bypassing the first approver 502. This processing is called “confirmation”. At this time, the mode of the form becomes a “correction confirmed” mode in the status information table 13. The change of mode from a correction confirmation request mode to a correction confirmed mode may be performed by applicant 501 inputting a predetermined command from client 20 or may be automatically performed by applicant 501 directing the continuation of the business affairs for the form after agreeing on the correction.

The next activity to which the form is transferred is determined by comparing the “route” defined in the form definition table 11 of FIG. 2 and the “route” shown in the status information table 13 of FIG. 4. For example, if the form with the form number “x01234” in the status information table 13 of FIG. 4 is a leave application form, it turns out from the “route” in the status information table 13 that the form has reached the activity of the superior and then it was sent back in correction confirmation request mode. Therefore, in the case of this form, it is determined that the form should be transferred to an activity of the personnel department that follows the superior in the “route” of form definition table 11.

On the other hand, when applicant 501 does not agree on the correction made by the first approver 502, he makes necessary corrections to the form and sends it to the first approver 502 again. This is the same as the process in a conventional workflow system, which does not have the approval with correction confirmation process according to the present invention. At this time, the mode of the form becomes a mode that indicates a normal reapplication. As described above, if the form does not meet the approval conditions at the first approver 502 and applicant 501 agrees on the correction made by the first approver 502, the form is transferred to the next activity omitting a repetitive approval step by the first approver 502. Namely, in this procedure, it is assumed that the first approver 502 will approve the form on condition that applicant 501 agrees on the correction made by the first approver 502. With such a procedure, the conventional process consisting of three kinds of processing, i.e., “send back”, “reapplication” and “approval”, is simplified to the one consisting of two kinds of processing, that is, “approval with correction confirmation” and “confirmation”. Furthermore, when the first approver 502 corrects the form, the process proceeds skipping the first approver 502 only if applicant 501 agrees on the correction, which makes clear that the responsibility for the application contents lies on applicant 501.

The above description assumes the first approver 502 performs the approval with correction confirmation. Likewise, if the correction confirmation property is established for an activity of the second approver 503, the second approver 503 may perform the approval with correction confirmation on the form, which has received the approval of the first approver 502. In this case the second approver 503 may send the corrected form back to applicant 501 or the first approver 502.

Generally, for a workflow having multiple stages of approval activities in the route, the correction confirmation property may be established for any activity. In this case, if a transactor (approver) for a predetermined activity performs the approval with correction confirmation, there may exist multiple activities at the previous stages prior to the transactor. In such a case, it is necessary to determine which prior activity the form should be returned. Different methods for determining where the form should be returned may be implemented. One specific method would be to allow the transactor who makes a correction to specify where the form should be returned. Another specific method would be to define the return locations at the system design stage. A third method would be to determine the last activity at which the form was updated and to return the form to that activity.

Moreover, in the workflow of FIG. 5, if the second approver 503 performs the approval with correction confirmation and then sends back the form to applicant 501 and even if applicant 501 agrees on the correction made by the second approver 503, the first approver 502 is involved since the first approver approved the form before it was corrected by the second approver 503. Therefore, if the second approver 503 performs the approval with correction confirmation, the first approver 502 needs to confirm after applicant 501 agrees on the correction.

Generally, if the approval with correction confirmation is performed by a transactor on the route (transactors on the route of the workflow excluding applicant 501) and then the form is sent back to a predetermined transactor, there may exist other activities between the transactor who performed the correction and the transactor to whom the form was sent back. In this case, if the transactor to whom the form was sent back agrees on the correction of the form, the correction needs to be confirmed by each of the transactors between the transactor to whom the form was sent back and the transactor who performed the correction. Therefore, in such a case, based on the history of processing of the form before it became the correction confirmation request mode, the form would repeat the route from the transactor to whom it was sent back to the transactor who made the correction, in order to be circulated to confirm the corrected contents at each of the activities on the route. In order to confirm the corrected contents at each of the activities on the route, the form may be circulated according to its essential route rather than its history of processing. However, if the essential route branches off, the history of processing is preferably used since the form needs to be circulated along the same route as the one in the processing before the correction.

The mode of the form is the correction confirmed mode when it is circulated through the transactors on the route. When the content of the form is modified by any activity, while the form is circulated through the activities at the previous stages prior to the transactor who performed the approval with correction confirmation, the form is changed from the correction confirmed mode to a mode that indicates a normal reapplication. Therefore, in this case, the form is to be processed again by an activity of the transactor who performed the approval with correction confirmation without skipping that activity.

The approval with correction confirmation process has been described with reference to the simple workflow shown in FIG. 5, according to the embodiment of the present invention, wherein the approval with correction confirmation process was extended if necessary to the case where the workflow has multiple stages of activities on the route. Needless to say, in the embodiment of the present invention, a transactor may send back the form as before rather than performing the approval with correction confirmation when the form needs a considerable correction to meet the approval conditions. Furthermore, when performing the approval with correction confirmation, the contents that the transactor can correct in the form (i.e., authority for correction) may be limited dependent on the stage of the workflow. In addition, dependent on the kind of the form or the corrected contents, the corrected form may be transferred to a next activity on the transactor's responsibility without performing the approval with correction confirmation.

A concrete example to which the approval with correction confirmation process according to the present invention is applied may be that an approver corrects mistakes of characters written in the form and then seeks confirmation of applicant 501. Another example may be that when the amount demanded in the budget application form exceeds the amount that an approver can approve, the approver corrects it to what he can approve and then seeks confirmation of applicant 501. A further example may be that an approver corrects the kind of leave in the leave application form to another kind of leave and then seeks confirmation of applicant 501. A still further example may be that if an employee applies for reservation of a recreation facility of the company using the application form but can not reserve a favorite recreation facility, an approver may correct the reservation to another recreation facility or to another period that can be reserved and then seeks confirmation of applicant 501.

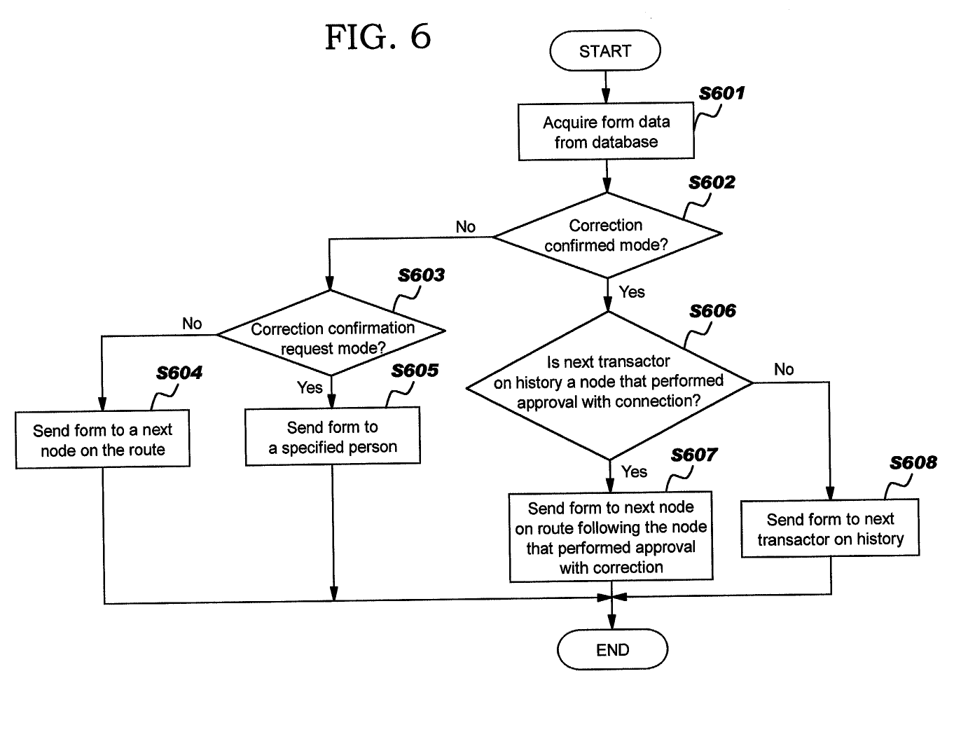

FIG. 6 is a flowchart illustrating the processing performed by form management section 14 in the workflow system according to the embodiment of the present invention shown in FIG. 1, which shows operations when the form is transferred from a predetermined activity on the workflow to a next activity.

As shown in FIG. 6, when the form is transferred from a predetermined activity to a next activity, form management section 14 first acquires information about the form from the form definition table 11 and status information table 13 (step 601). Then, it refers to the “mode” of status information table 13 to determine whether the form is in the correction confirmed mode (step 602).

If the form is not in the correction confirmed mode, the form management section 14 determines whether the form is in the correction confirmation request mode (step 603). If the form is neither in the correction confirmation request mode, it proves that the form is to proceed to a next activity through normal processes, thus the form management section 14 sends the form to a next activity based on the “route” defined in the form definition table 11 (step 604).

If the form is in the correction confirmation request mode, the form is to be sent back from the approver to the predetermined activity based on the approval with correction confirmation, thus the form management section 14 sends back the form to where the approver specifies (step 605). It is noted that where the form is to be sent back may be stored in an item established in the status information table 13, whereby the form management section 14 can recognize.

On the other hand, if the form is in the correction confirmed mode in step 602, it proves that the correction made by the approver has been accepted and the form is now on the history route again. Accordingly, the form management section 14 refers to the “route” of the status information table 13 to determine whether a transactor of a next activity is the approver who performed the approval with correction confirmation (step 606). If so, the form management section 14 sends the form to a further next activity skipping the former next activity (step 607). On the contrary, if the transactor of the next activity is not the approver who performed the approval with correction confirmation in step 606, the form management section 14 sends the form to that next activity (step 608). The reason for sending the form to the next activity when the transactor of the next activity is not the approver who performed the approval with correction confirmation is to circulate the corrected form when the form is sent back to an activity located several stages earlier in the workflow that has multiple stages of approval processing.

Next, it will be described about the interface of the workflow system according to the embodiment of the present invention. As described above, the form edit/display control section 15 of server 10 creates and edits the form, and then generates the display screen as an interface for performing the processing at each activity on the workflow, and then sends it to client 20. Client 20 accepts the processing performed on this display screen and the results are reflected in the application information table 12 and status information table 13.

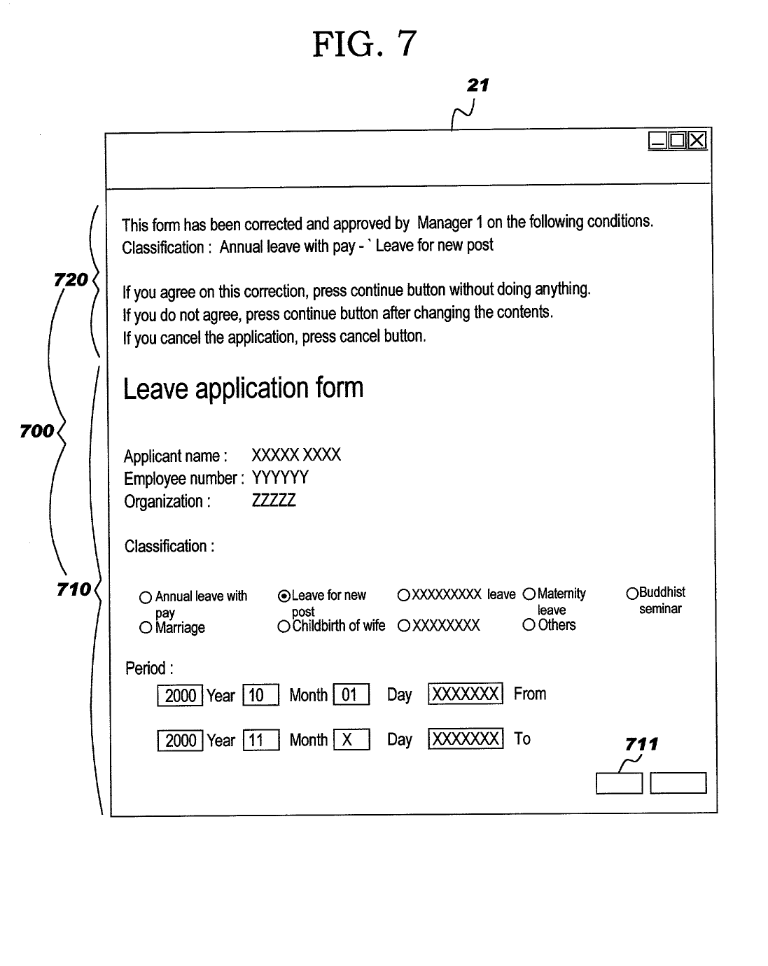

The form edit/display control section 15 provides a display screen for performing the processing in the correction confirmation request mode as well as a display screen for performing the processing on the form in a normal mode. FIG. 7 depicts an example configuration of a display screen of the form for use in performing the processing in the correction confirmation request mode. In FIG. 7, there is shown a display screen where the approval with correction confirmation has been performed on the leave application form by a predetermined approver and the form has been sent back to the applicant (issuer).

This display screen 700 is generated by the form edit/display control section 15 based on the application information table 12 and status information table 13 and is sent to client 20 that performs business affairs. Then, browser 21 in client 20 displays this display screen 700 on the display means such as a display. Referring to FIG. 7, display screen 700 consists of a form display field 710 for displaying the form itself and a message field 720 for notifying that this form has been sent back in the correction confirmation request mode based on the approval with correction confirmation.

Form display field 710 is displayed whenever the business affairs are performed at each activity, such as when the form is issued and approved. When being issued, necessary information is input to the input form of the form display field 710. When being approved, determination is made as to whether the contents displayed in the form display field 710 should be approved. Then, selecting a continue button 711 terminates the business affairs at this activity and transfers the form to a next activity. In message field 720, there are shown that the approval with correction confirmation has been performed on this form, and the contents of the correction, and operator guidance when agreeing on the correction (i.e., accepting the correction) and when not agreeing on the correction (i.e., rejecting the correction), etc. The applicant determines whether or not to accept this correction by performing operations according to the guidance in the message field 720.

Operations performed on the display screen 700 are sent from client 20 to server 10 using the functions of browser 21. The form edit/display control section 15 in server 10 accepts the operations and performs any processing depending on the operations, including storing or changing of information in the application information table 12 or status information table 13. In the example shown in FIG. 7, when continue button 711 in the form display field 710 is selected, the form edit/display control section 15 automatically determines whether the applicant agreed on the correction based on whether the contents in the form display field 710 have been corrected by the applicant.

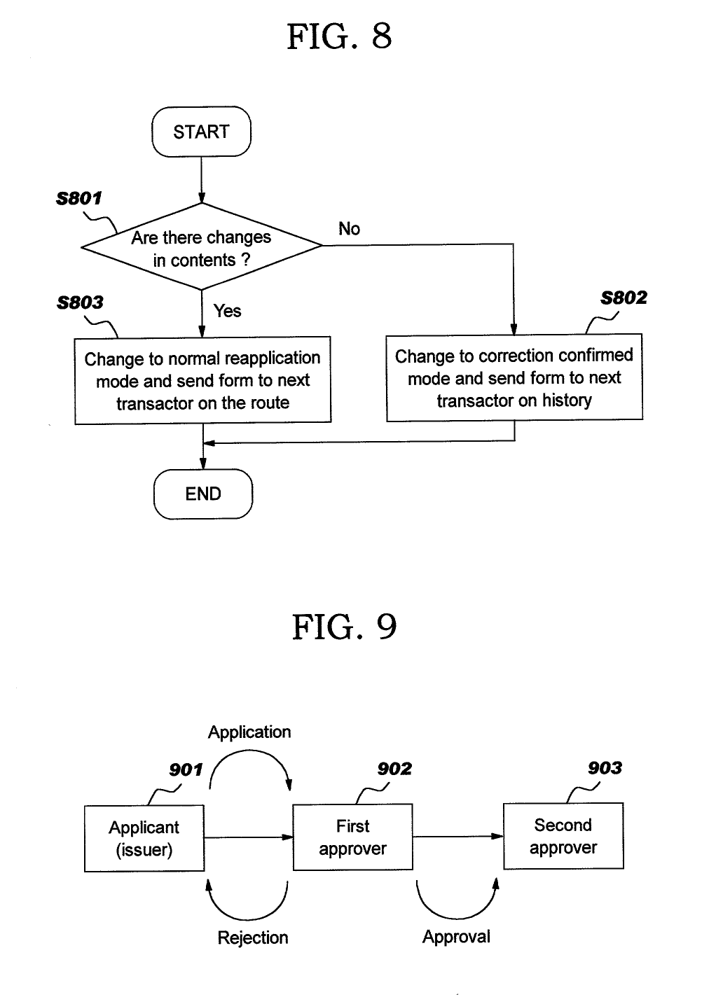

FIG. 8 depicts a flowchart illustrating operations performed by the form edit/display control section 15. In operations shown in FIG. 8, it is assumed as the initial conditions that continue button 711 in the form display field 710 of display screen 700 shown in FIG. 7 is selected. In response to this, the form edit/display control section 15 determines whether there are changes in the contents of the form (step 801). If no change exists, it determines that the applicant accepted the correction made by the approver and therefore changes the “mode” of the form in the status information table 13 to the correction confirmed mode (step 802). On the other hand, if there are some changes in the contents of the form, it determines that the applicant did not accept the correction made by the approver and therefore changes the “mode” of the form in the status information table 13 to a mode indicating a normal reapplication (step 803).

In operations shown in FIG. 7 and FIG. 8, the form edit/display control section 15 automatically determines whether the applicant accepted the correction of the form dependent on the status data of the form when continue button 711 is selected. Alternatively, when displaying the form in the correction confirmation request mode, the form edit/display control section 15 may provide in the display screen 700 a means for causing the applicant to indicate his decision (e.g., button) as to whether or not to accept the correction of the form, thereby prompting the applicant's input.

What is claimed is:

1. A workflow system for managing a series of processes in a predetermined workflow, the system including multiple terminal devices connected to a network and comprising:
an inquiry device, responsive to return of corrected data from a second activity to a first activity, to send an inquiry to the first activity to determine whether the first activity agrees with the corrected data; and
a management device, responsive to an indication from the first activity that it agrees with the corrected data, for forwarding the corrected data to another workflow activity on a path that bypasses the second activity.

2. A workflow system according to claim 1 wherein said management device allows the corrected data to be forwarded to the second activity if it is determined that the first activity made changes in the corrected data returned from the second activity.

3. The workflow system according to claim 1 wherein the system includes one or more activities between the first activity and the second activity in the workflow and wherein said management device causes corrected data accepted by the first activity to be routed through each of said one or more activities.

4. A workflow system, comprising:
terminal devices for performing individual activities in a series of business processes; and
a workflow server connected to said terminal devices via a network to manage said business processes based on a predetermined workflow, said workflow server responding to acceptance of corrected data by a first stage where the correction was first made at a second stage to route the corrected data along a workflow path which excludes the second stage.

5. A workflow system according to claim 4, wherein said workflow server returns data with corrections proposed by the second stage to an earlier processing stage other than the first stage.

6. A workflow system according to claim 4, wherein said workflow server routes data to the second stage where changes to the proposed corrections are made at a stage prior to the second stage.

7. A workflow system, comprising:
terminal devices for performing individual processing of a series of business processes; and
a workflow server connected to said terminal devices via a network and managing said business processes based on a predetermined workflow, wherein if a processed result at a certain processing stage (the first stage) is corrected and then approved at another processing stage (the second stage) on a route of the workflow, the workflow server advances the business process to a next processing stage on condition that the correction is accepted at the first stage.

8. A workflow server connected to multiple terminal devices for managing business processes consisting of processing performed by the terminal devices based on a predetermined workflow, the server comprising:
an acceptance element for accepting correction to a processed result of a first activity at a second activity on a route of the workflow;
a management element for sending back accepted corrections to the first activity; and
a notification element for notifying the first activity that the correction were accepted.

9. A workflow server according to claim 8, wherein said management element advances the corrected data to another activity on said route of the workflow bypassing the second activity that made the correction, if said correction is agreed on by the first activity to which the processed result was sent back.

10. A workflow server according to claim 8 further comprising a history element for retaining a history of processing performed, wherein if there exists one or more activities on the route between the first activity and the second activity, the management element directs accepted corrected data back to such activities according to the history retained in said history element.

11. A workflow server according to claim 9 said management means appends mode information to corrected data for management to the processed result.

12. A business process management method for managing business processes based on a predetermined workflow, which includes processing performed by multiple terminal devices connected to a network, the method comprising the steps of:
reviewing a processed result produced at a first processing stage at a second processing stage on a route of the workflow;
sending proposed corrections to the result to the first stage; and
responding to acceptance of the proposed corrections at the first stage to send the corrected results directly to a processing stage subsequent to the second processing stage.

13. A business process management method according to claim 12 sending the corrected results to one or more processing stages intermediate the first and second processing stages in the predetermined workflow.
